(19) United States
(12) Patent Application Publication
(10) Pub. No.: US 2015/0364271 A1
(43) Pub. Date: Dec. 17, 2015

(54) ROTATING SLEEVE LOCK SWITCH

(71) Applicant: Union Precision Industry, Inc., Arcadia, CA (US)

(72) Inventor: George Huang, Arcadia, CA (US)

(73) Assignee: Union Precision Industry, Inc.

(21) Appl. No.: 14/307,021

(22) Filed: Jun. 17, 2014

(51) Int. Cl. H01H 9/22; H01H 13/14; G05G 5/00

(52) U.S. Cl. CPC H01H 9/22; G05G 5/005; H01H 13/14

(57) ABSTRACT

A rotating sleeve lock switch comprising a main body, and a button having an axis. The button is mounted to the main body. A first engagement member is formed on the button. A sleeve lock is rotably mounted to the main body, and the sleeve lock has a sleeve lock internal surface. The sleeve lock internal surface has a second engagement member that is configured to receive the first engagement member when the sleeve lock is in an unlocked position. A button stop shoulder is formed on the sleeve lock and the button stop shoulder engages the first engagement member to prevent pressing of the button when the sleeve lock is in a locked position. Preferably, the first engagement member is a protrusion, and the second engagement member is an indentation.

### FIELD OF THE INVENTION

The present invention is in the field of electrical switches.

### DISCUSSION OF RELATED ART

A variety of switches have a locking mechanism for mechanically disabling a mechanical switch. For example, in U.S. Pat. No. 3,003,803 Rear door safety lock, the door lock requires a user to turn a knob to push a mechanical button for actuating the door lock.

Also, U.S. Pat. No. 4,541,257 entitled Safety lock for automobiles, describes a locking sleeve for an automobile with a manual transmission operable by a shift stick.

### SUMMARY OF THE INVENTION

A rotating sleeve lock switch comprising a main body, and a button having an axis. The button is mounted to the main body. A first engagement member is formed on the button. A sleeve lock is rotably mounted to the main body, and the sleeve lock has a sleeve lock internal surface. The sleeve lock internal surface has a second engagement member that is configured to receive the first engagement member when the sleeve lock is in an unlocked position. A button stop shoulder is formed on the sleeve lock and the button stop shoulder engages the first engagement member to prevent pressing of the button when the sleeve lock is in a locked position. Preferably, the first engagement member is a protrusion, and the second engagement member is an indentation.

The rotating sleeve lock switch has a button position spring having a spring arm terminating in a spring arm tip. The sleeve lock internal surface includes a position slot formed in a parallel direction to the axis. The position slot engages and disengages the spring arm tip as the sleeve lock rotates around the main body and around the button. A contact is mounted to the button. The contact has a contact retaining surface that engages an inside surface of the main body to retain the button to the main body.

The sleeve lock stop shoulder is formed on the main body, and has a sleeve retainer having a sleeve retainer ring flange that extends from the sleeve retainer. The sleeve retainer is mounted to the main body at a sleeve retainer thread. The sleeve lock is retained in a rotable state between the sleeve lock stop shoulder and the sleeve retainer ring flange.

A button helical spring is mounted in a button helical spring slot formed on the main body. The button helical spring biases the button into a neutral position. A sleeve lock stop shoulder is formed on the main body. A sleeve retainer can have a sleeve retainer ring flange that extends from the sleeve retainer. The sleeve retainer is mounted to the main body at a sleeve retainer thread. The sleeve lock is retained in a rotable state between the sleeve lock stop shoulder and the sleeve retainer ring flange. A button helical spring is mounted in a button helical spring slot formed on the main body. The button helical spring biases the button into a neutral position. The sleeve lock is configured to transition between the locked position and the unlocked position by rotation of the sleeve lock.

### BRIEF DESCRIPTION OF THE DRAWINGS

FIG. 1 is a rear perspective exploded view of the present invention.

FIG. 2 is a front perspective exploded view of the present invention.

FIG. 3 is a rear view of the present invention.

FIG. 4 is a side cross-section view of the present invention.

FIG. 5 is a side exploded view of the present invention.

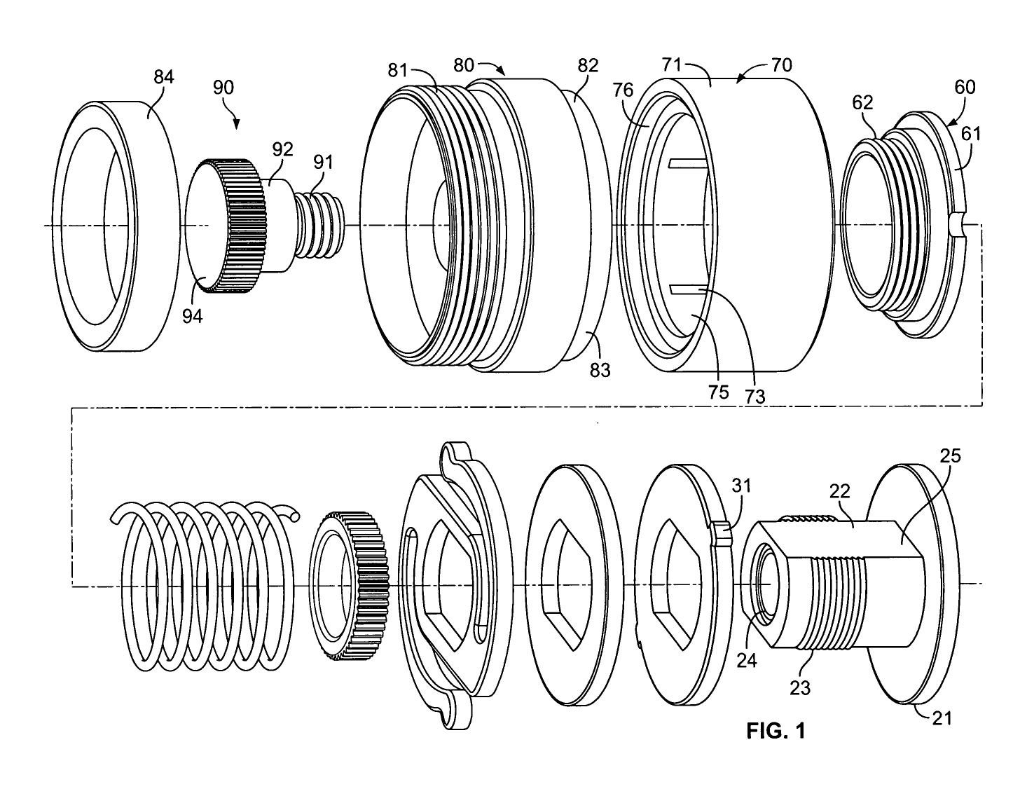

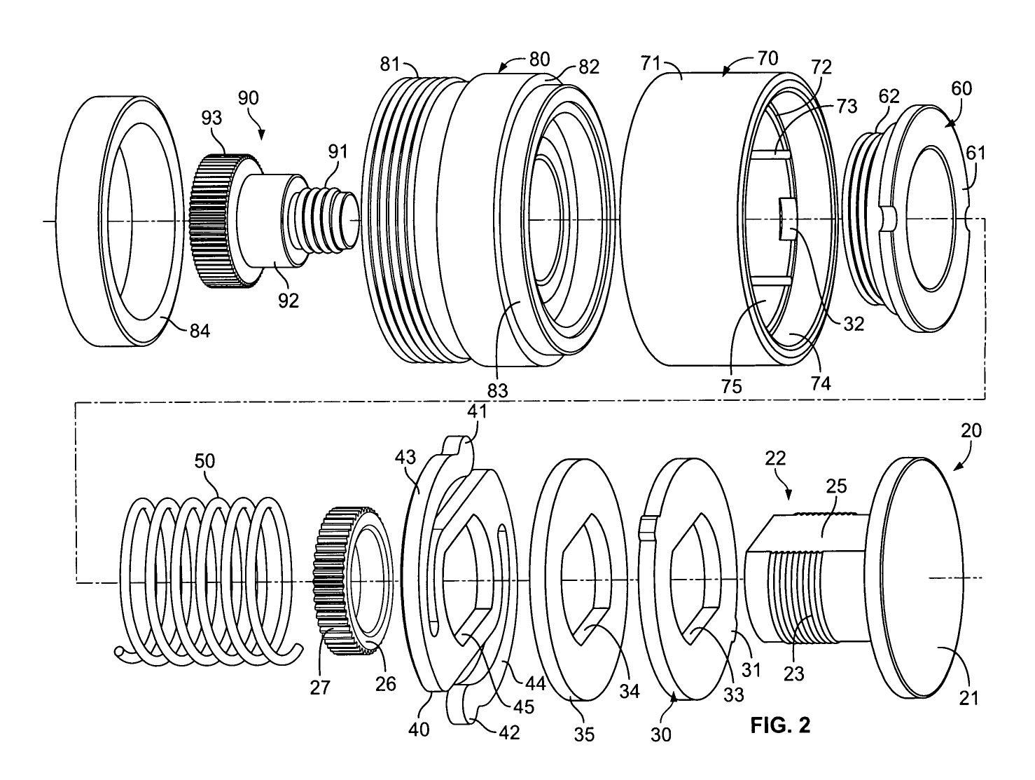

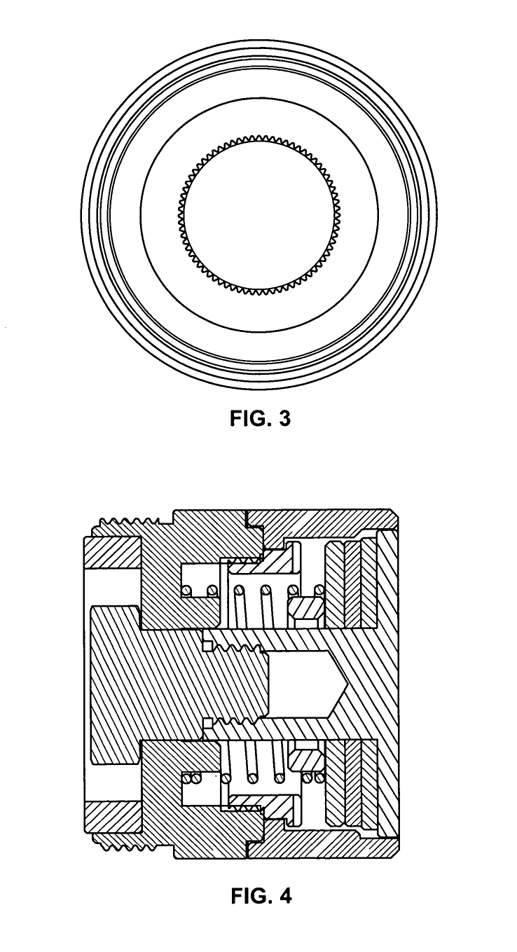

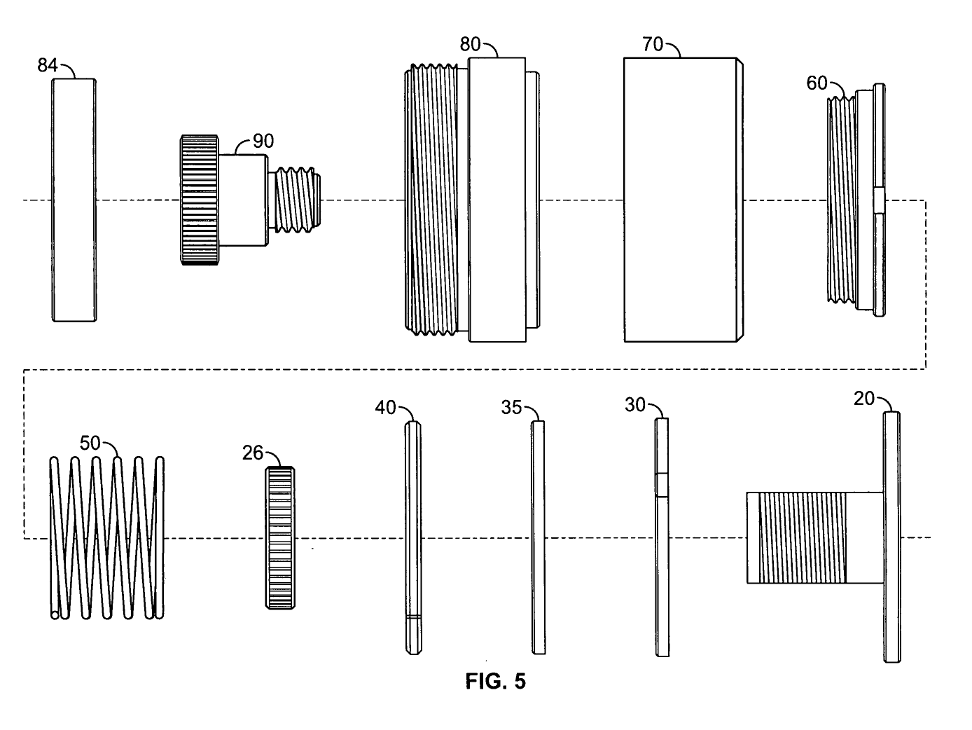

The following call out list of elements can be a useful guide in referencing the elements of the drawings.

20 Button

21 Button Face

22 Button Stem

23 Button Stem Thread

24 Button Stem Socket

25 Button Stem Non-Cylindrical Surface

26 Button Stem Thread Nut

27 Button Stem Thread Nut Grip

30 Button Adapter

31 Protrusion

32 Indentation

33 Button Adapter Opening Each

34 Button Spacer Opening

35 Button Spacer

40 Button Position Spring

41 First Spring Tip

42 Second Spring Tip

43 First Spring Arm

44 Second Spring Arm

45 Button Position Spring Opening

50 Button Helical Spring

60 Sleeve Retainer

61 Sleeve Retainer Ring Flange

62 Sleep Retainer Thread

70 Sleeve Lock

71 Sleeve Lock Outer Surface

72 Button Stop Shoulder

73 Position Slot

74 Button Opening

75 Sleeve Lock Internal Surface

76 Sleeve Mounting Rim

80 Main Body

81 Main Body External Thread

82 Sleeve Lock Stop Shoulder

83 Sleeve Retainer Rim

84 Main Body Inside Ring

90 Contact

91 Contact Thread

92 Contact Stem

93 Contact Grip

94 Contact Face

### DETAILED DESCRIPTION OF THE PREFERRED EMBODIMENT

According to the figures, the present invention is a button that has a sleeve lock for selectively locking the button from activation. Button 20 has a released position which is a neutral position, and an engaged position which is a depressed position. The button 20 has a button face 21 which can be a circular disk exposed to the user. The user may press the button face 21 with a finger. The button face can be made of a metal disc that has a button stem 22. The button stem 22 is elongated and has a button stem thread 23 formed on a left and right side of the button stem 22. The button stem 22 may also have button stem socket 24 disposed at a terminal end opposite the button face 21. The button stem socket 24 can be threaded for receiving a contact thread 91. The button stem is generally cylindrical, but may have a flat surface that is not cylindrical. The flat surface could also be made as a slot or protrusion that is not cylindrical so as to provide a button stem non-cylindrical surface 25. The button stem non-cylindrical surface 25 resists rotation relative to other members after a button stem thread nut secures a button adapter 30, a button spacer 35, and a button position spring 40 to the button stem 22. The button stem thread nut 26 can have an external surface formed as a grip to provide a button stem thread nut grip 27.

The button adapter 30 has a button adapter opening 33 sized to fit to the button stem 22 and the button stem non-cylindrical surface 25. The button adapter 30 has a protrusion 31 that is aligned to fit into an indentation of the sleeve lock 70 when the button is in unlocked position. The button adapter 30 may have the protrusion not aligned with the indentation 32 when the button is in a locked position. The button adapter 30 can be made as a separate piece of metal from the button 20, however the button adapter 30 can also be made of the same piece of metal as the button 20. When the button adapter 30 is made as a separate piece or separate parts, the button adapter 30 can have varying numbers and positions of protrusions. For example, having a single protrusion 31 that can engage with a single indentation 32 provides a single unlocked position in a 360° rotation. Having a pair of protrusions 31 that engage with a pair of indentations 32 provides a pair of unlocked positions in a 360° rotation. Having three protrusions 31 that engage with three indentations 32 provides three unlocked positions within a 360° rotation such that went equally distantly spaced, a user need only rotate the sleeve by less than half a turn.

The button adapter 30 abuts the button spacer 35 which has a button spacer opening 34 sized to engage with the button stem 22. The button spacer 35 can be made of a plastic or metal material that allows slippage. Also, the button spacer 35 can be oiled so that it slides relative to the button position spring 40. The button adapter and the button spacer can be integrally formed with the button 20 so that the protrusions 31 can be formed on the button 20. Optionally, the button adapter and the button spacer can be separately formed to allow personalization options via modular configuration and reconfiguration such as by an end-user. The best mode is believed to be configuring the button 20 to include a button spacer 35 and button adapter 30 portion as an integral part of the button 20. Integral formation of the button 20 can be by a single cast of a metal mold, or can be a single plastic injection molded piece.

The button's position spring 40 has a pair of spring arms, namely a first spring arm 43 and a second spring arm 44. The first spring arm 43 terminates at a first spring tip 41, and the second spring arm 44 terminates at a second spring tip 42. The first spring arm 43 and the second spring arm 44 have a spiral configuration relative to a central button position spring opening 45. The button position spring 40 is generally planar with the first button spring tip 41 and the second button spring tip 42 engaging the sleeve lock internal surface 75. The first button spring tip 41 and the second button spring tip 42 engage with the position slots 73 formed on an inside surface of the sleeve lock 70 which is known as the sleeve lock internal surface 75. The spacing of the button spring tips allows a user to have a set defined position, tactile reinforcement, and optionally an audible click when the spring tip engages the position slot 73. The position slots 73 are aligned with the location of the first and second spring tips so that the spring tips engage the position slots 73 when the indentation 32 aligns with the protrusion 31.

The buttons stem thread nut 26 preferably does not engage the first spring arm 43 and the second spring arm 44, but rather only secures the button position spring 40 near the central button position spring opening 45 so that the first spring arm 43 in the second spring arm 44 are free to move outward and inward as they engage the sleeve lock internal surface 75. If the first button spring tip 41 and the second button spring tip 42 are pointed, they can limit rotation to a counterclockwise or clockwise only rotation. Limiting to a one-way rotation may at some times be preferable.

The button helical spring 50 has a larger diameter than the button stem thread nut 26 and engages the button position spring 40 near the button position spring opening 45 to bias the button into a neutral position. The button helical spring 50 restores the position of the button after the button is depressed by a finger. The button helical spring 50 is seated in a button helical spring groove located on the main body 80.

The sleeve lock 70 is mounted to the main body 80 using a sleeve retainer 60. The sleeve retainer 60 has a sleeve retainer ring flange 61. The sleeve retainer ring flange may further include a pair of semicircular openings to allow a wrench tool to turn the sleeve retainer ring flange relative to the main body 80 for the purpose of installing the sleeve retainer ring flange. The sleeve lock 70 is therefore loosely sandwiched between the main body 80 and the sleeve retainer 60, so that the sleeve lock 70 can rotate relative to the main body 80 and can rotate relative to the sleeve retainer 60. The sleeve retainer 60 has sleeve retainer thread 62 that engages the main body 80.

The sleeve lock 70 has a sleeve lock outer surface 71 that is symmetrical and can also receive a grip surface for superior tactile confirmation. The sleeve lock internal surface 75 has an indentation 32 and a position slots 73. The sleeve lock 70 has a button opening 74 that terminates at a button stop shoulder 72. The button face 21 travels along the button opening 74 and stops when the inside external periphery surface of the button face 21 engages the button stop shoulder 72. The button stop shoulder 72 is formed as a ring shaped area of lesser diameter that is deeper than the button opening 74.

The sleeve lock 70 has a sleeve mounting rim 76 that engages with a sleeve retainer rim 83 of the main body 80. The sleeve mounting rim 76 of the sleeve lock 70 fits over the sleeve retainer rim 83. The sleeve lock 70 is retained between the sleeve lock stop shoulder 82 of the main body and the sleeve retainer ring flash 61 of the sleeve retainer 60. The main body 80 also has a main body external thread 81 on its external circumferential periphery to provide mounting to a larger external electrical device.

The contact 90 has contact thread 91 formed on a contact stem 92. The contact 90 also has contact grip 93 that can provide a grip for a user to install the contact thread 91 into the button stem socket 24. The contact 90 also has a contact face 94. The contact face 94 can touch a variety of different electrical contacts to provide a closed circuit. The contact face moves with the woman of the button 20. Optionally, a main body inside ring 84 can be installed to the main body 80, and the main body inside ring 84 can have a wire coil to sense a capacitance change of the contact face 94 for example in a capacitance switch. In a contact switch, the main body inside ring could have a lighted LED for indicating and confirming a depression of the button 20. The contact 90 has a contact retaining surface that engages an inside surface of the main body 80 to retain the button 20.

1. A rotating sleeve lock switch comprising:
a. a main body;
b. a button having an axis, wherein the button is mounted to the main body;
c. a first engagement member formed on the button;
d. a sleeve lock rotably mounted to the main body, wherein the sleeve lock has a sleeve lock internal surface, wherein the sleeve lock internal surface has a second engagement member that is configured to receive the first engagement member when the sleeve lock is in an unlocked position; and
e. a button stop shoulder formed on the sleeve lock, wherein the button stop shoulder engages the first engagement member to prevent pressing of the button when the sleeve lock is in a locked position, wherein the sleeve lock is configured to transition between the locked position and the unlocked position by rotation of the sleeve lock.

2. The rotating sleeve lock switch of claim 1, further comprising: a button position spring having a spring arm terminating in a spring arm tip, wherein the sleeve lock internal surface includes a position slot formed in a parallel direction to the axis, wherein the position slot engages and disengages the spring arm tip as the sleeve lock rotates around the main body and around the button.

3. The rotating sleeve lock switch of claim 1, further comprising: a contact mounted to the button, wherein the contact has a contact retaining surface that engages an inside surface of the main body to retain the button to the main body.

4. The rotating sleeve lock switch of claim 1, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange.

5. The rotating sleeve lock switch of claim 1, further comprising: a button helical spring mounted in a button helical spring slot formed on the main body, wherein the button helical spring biases the button into a neutral position.

6. The rotating sleeve lock switch of claim 1, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange; and a button helical spring mounted in a button helical spring slot formed on the main body, wherein the button helical spring biases the button into a neutral position.

7. The rotating sleeve lock switch of claim 1, wherein the first engagement member is a protrusion, and wherein the second engagement member is an indentation.

8. The rotating sleeve lock switch of claim 7, further comprising: a button position spring having a spring arm terminating in a spring arm tip, wherein the sleeve lock internal surface includes a position slot formed in a parallel direction to the axis, wherein the position slot engages and disengages the spring arm tip as the sleeve lock rotates around the main body and around the button.

9. The rotating sleeve lock switch of claim 7, further comprising: a contact mounted to the button, wherein the contact has a contact retaining surface that engages an inside surface of the main body to retain the button to the main body.

10. The rotating sleeve lock switch of claim 7, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange.

11. The rotating sleeve lock switch of claim 7, further comprising: a button helical spring mounted in a button helical spring slot formed on the main body, wherein the button helical spring biases the button into a neutral position.

12. The rotating sleeve lock switch of claim 7, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange; and a button helical spring mounted in a button helical spring slot formed on the main body, wherein the button helical spring biases the button into a neutral position.

13. The rotating sleeve lock switch of claim 7, wherein the button includes a button spacer portion and button adapter portion as an integral part of the button.

14. The rotating sleeve lock switch of claim 13, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange.

15. The rotating sleeve lock switch of claim 13, further comprising: a sleeve lock stop shoulder formed on the main body, and further comprising a sleeve retainer having a sleeve retainer ring flange that extends from the sleeve retainer, wherein the sleeve retainer is mounted to the main body at a sleeve retainer thread, wherein the sleeve lock is retained in a rotable state between the sleeve lock stop shoulder and the sleeve retainer ring flange; and a button helical spring mounted in a button helical spring slot formed on the main body, wherein the button helical spring biases the button into a neutral position.
